(19) United States
(12) Patent Application Publication
(10) Pub. No.: US 2010/0283272 A1
(43) Pub. Date: Nov. 11, 2010

(54) Pivoting Brush Guard with Latch Mechanism for Providing Quick Engine Access

(75) Inventor: Douglas Edward Schneider, Strasburg, IL (US)

Correspondence Address: VEDDER PRICE P.C., 222 N. LASALLE STREET, CHICAGO, IL, 60601, US

(73) Assignee: Agri-Fab, Inc., Sullivan, IL (US)

(21) Appl. No.: 12/435,867

(22) Filed: May 5, 2009

(51) Int. Cl. B60R 19/52

(52) U.S. Cl. 293/115

(57) ABSTRACT

A brush guard used on a vehicle, for example, on a lawn tractor. The brush guard includes a latch mechanism that allows the brush guard to be closely mounted to the vehicle's engine cover for esthetic reasons. When an operator needs to open the vehicle's front engine cover, which typically tilts forward, the operator may release a latch mechanism and pivot the brush guard forward and away from the engine cover such that the engine cover is not blocked and may be opened. A tension spring returns a latch pin to the latched position such that no manipulation of the latch mechanism is needed when the brush guard is repositioned in an upright operating position. To reposition the brush guard into the operating position, the operator may lift the brush guard upwardly toward the vehicle engine cover, and the latch pin will reengage into its latching position.

### FIELD OF THE DISCLOSURE

The present disclosure is related to brush guards that attach to a vehicle front end, such as a tractor or truck front end, that protect the vehicle front end from damage.

### BACKGROUND

Vehicles such as, but not limited to, lawn tractors often utilize a front end guard or brush guard to protect the vehicle from contact damage that may occur during use. The brush guard is usually attached by bolting or welding the brush guard frame to suitable mechanical points on the tractor frame. The problem with such attachments is that they usually block access to the vehicle's hood and thus block access to the vehicle's engine. The brush guard therefore may need to be completely removed from the vehicle in order to open the hood to access the engine. Although brush guards can be designed such that a section is removable from the frame, such designs would still require tools, and time, to remove the section of the brush guard so that the hood of the vehicle can be opened.

Therefore a need exists for brush guards that can be quickly removed or repositioned, without the need for tools, such that the vehicle's hood may be opened to access the engine.

### BRIEF DESCRIPTION OF THE DRAWINGS

FIG. 1 is a side view of a tractor front end having a pivoting brush guard attached to the front end and placed in a deployed position.

FIG. 2 is a side view of the tractor front end shown in FIG. 1, wherein the pivoting brush guard is pivoting away from the tractor front to allow access to the tractor hood for engine access.

FIG. 3 is a side view of a pivoting brush guard shown in FIGS. 1 and 2, and shows details of a brush guard latch mechanism in accordance with an embodiment.

FIG. 4 is a top view of the pivoting brush guard shown in FIGS. 1 and 2, and shows the tension springs connected to the latch pin.

FIG. 5 is a front view of the pivoting brush guard shown in FIGS. 1 and 2.

FIG. 6 is a bottom view of the pivoting brush guard shown in FIGS. 1 and 2.

FIG. 7 is a side perspective view of the pivoting brush guard shown in FIGS. 1 and 2.

FIG. 8 is a rear perspective view of the pivoting brush guard shown in FIGS. 1 and 2.

FIG. 9 is a bottom perspective view of the pivoting brush guard shown in FIGS. 1 and 2.

FIG. 10 is a cross-sectional view of a section of FIG. 3 illustrating an embodiment employing a shoulder bolt.

FIG. 11 is a cross-sectional view of a section of FIG. 3 illustrating an alternative embodiment to the embodiment shown in FIG. 10, where a press fit stop dowel is used instead of a shoulder bolt.

FIG. 12 is a cross-sectional view of a section of FIG. 3 illustrating an alternative embodiment to the embodiments shown in FIGS. 10 and 11, where a press fit follower dowel on the pivot arm is used instead of a dowel on the stationary frame brace member and instead of using a shoulder bolt.

FIG. 13 s a side view of the pivoting brush guard shown in FIG. 3, in an unlatched, tilted position in accordance with an embodiment.

### DETAILED DESCRIPTION

The present disclosure provides a brush guard used on a vehicle, for example, on a lawn tractor. The brush guard includes a latch mechanism that allows the brush guard to be closely mounted to the vehicle's engine cover for esthetic reasons. When an operator needs to open the vehicle's front engine cover, which typically tilts forward, the operator may release the brush guard latch mechanism and pivot the brush guard forward and away from the engine cover such that the engine cover is not blocked and may be opened. A tension spring returns a latch pin of the latch mechanism to the latched position such that no manipulation of the latch mechanism is needed when the brush guard is repositioned in an upright operating position.

The latch mechanism of the embodiments is operated by pulling a latch pin forward and out of its latching position. After the latch pin is moved, the brush guard may be lowered by rotation about a pivot point, such that the brush guard is positioned away from the front of the vehicle front end. A tension spring exerts a pulling force on the latch pin to pull the latch pin back into its latching position when the brush guard is repositioned into the operating position. To reposition the brush guard into the operating position, the operator may lift the brush guard upwardly toward the vehicle engine cover, and the latch pin will reengage into its latching position.

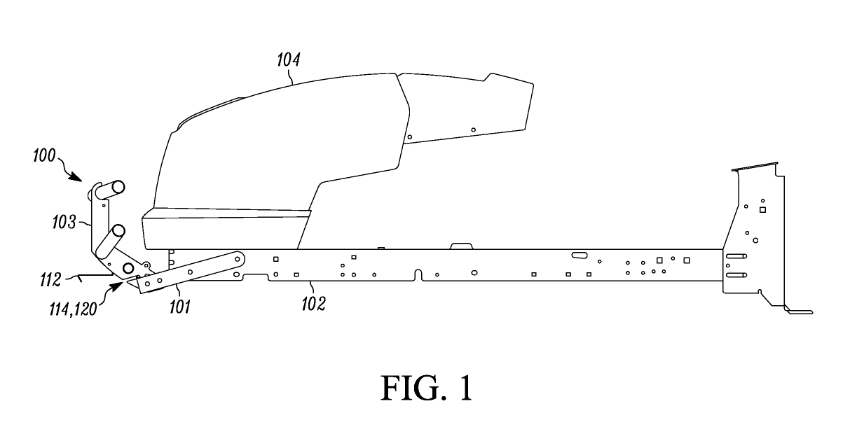

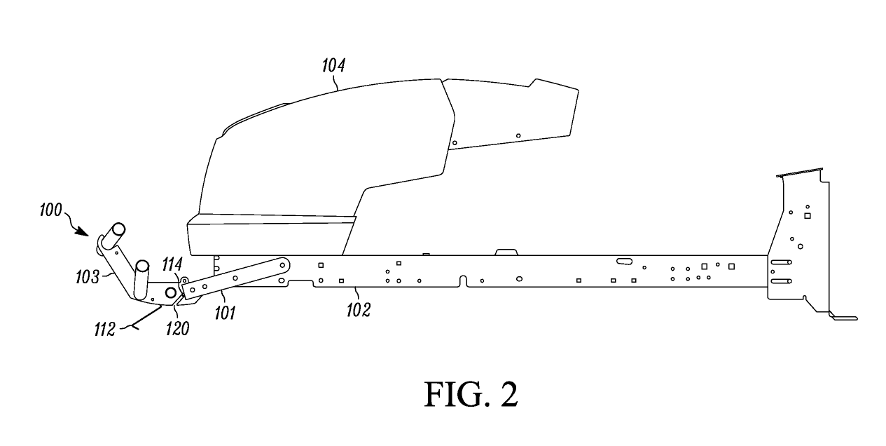

Turning now to the drawings wherein like numerals represent like components, FIG. 1 illustrates a brush guard assembly 100 in accordance with an embodiment. The brush guard assembly 100 is mounted onto a vehicle 104 front end, which may be, for example, a lawn tractor. The vehicle includes a vehicle frame 102 onto which the brush guard assembly 100 may be mounted. The brush guard assembly includes a stationary frame brace 101, which is mounted to the vehicle frame 102, and a pivoting brush guard 103. The pivoting brush guard 103 is shown in FIG. 1 in a deployed or operating position, and is latched in place via a latch mechanism which is described below in further detail. FIG. 2 illustrates how the pivoting brush guard 103 may be pivoted, or tilted, away from the vehicle 104 front end such that the engine cover may be tilted to access the vehicle 104 engine as needed.

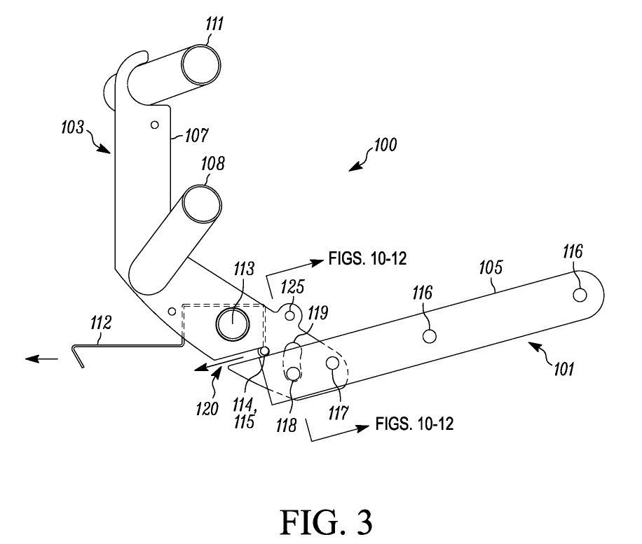

FIG. 3 provides a side view of the brush guard assembly 100 illustrated in FIGS. 1 and 2. In FIG. 3, the brush guard assembly 100 is shown in a deployed position as also shown in FIG. 1. In the deployed, or upright position, the pivoting brush guard 103 is latched by a latch pin 114 which supports the weight of the pivoting brush guard 103 and rests against the stationary frame brace 101. The pivoting brush guard 103 includes latch pin slots 120. The latch pin 114 is positioned within the latch pin slots 120 when in a latched position and prevents the pivoting brush guard 103 from forward rotation, or forward pivoting, because the latch pin 114 withstands a downward shear force produced by the pivoting brush guard 103.

The latch pin 114 may include an attached handle 112, which can be used by an operator to disengage the latch pin 114 from the latch pin slots 120. To disengage the latch pin 114, an operator may pull forward on handle 112 in the direction of the arrow shown in FIG. 3, to pull the latch pin 114 out of the slots 120. The operator may also place a slight pushing force on the pivoting brush guard 103, to remove the shear force of the brush guard 103 weight upon the latch pin 114, to allow the latch pin 114 to be easily pulled forward and removed from slots 120. The pivoting brush guard 103 may then be rotated, or pivoted, forward, that is, in a direction away from the vehicle front end as was illustrated in FIG. 2. The pivot point 117 provides the point of rotation or pivoting and is described in further detail below. The handle 112 may, in some embodiments, rest upon the pivot tube 113, which may provide a stop point to prevent the handle 112 from being pulled too far forward. The pivot tube 113 may also be considered to be a structural connecting member, or a structural horizontal connecting member, for connecting the right pivot arm 107 to the left pivot arm 109.

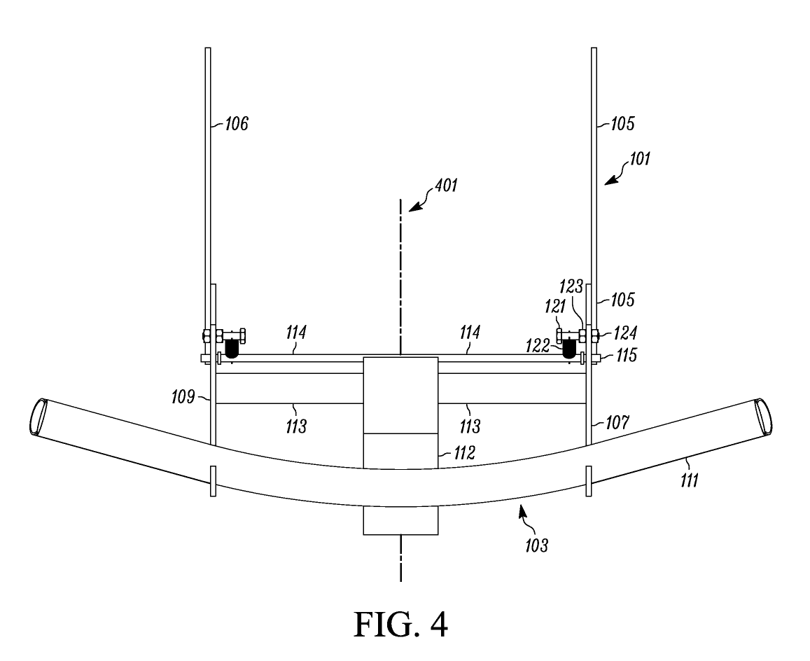

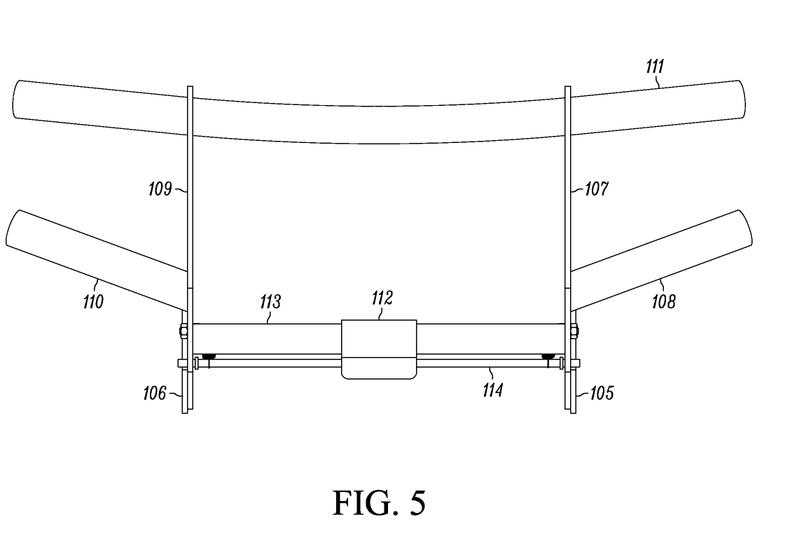

FIG. 4 is a top view that shows further details of the brush guard assembly 100, and provides a more detailed view of the latch mechanism of the illustrated embodiment. For purposes of explanation, the brush guard assembly 100 will be described further as having a left side and a right side, relative to facing the brush guard assembly 100 from the front. For example, FIG. 5 illustrates what will be considered the brush guard assembly 100 “front view” for purposes of explanation. Therefore, with respect to FIG. 4 and FIG. 5, the stationary frame brace 101 is shown having a right brace member 105 and a left brace member 106. The pivoting brush guard 103 includes a right pivot arm 107 and a left pivot arm 109. The right pivot arm 107 and left pivot arm 109 provide structural support for guard tubes such as main guard tube 111. The main guard tube 111 may also be considered to be a structural connecting member, or a structural horizontal connecting member, for connecting the right pivot arm 107 to the left pivot arm 109.

The latch pivot tube 113 extends horizontally across the width of the brush guard assembly 100, and is attached to the right pivot arm 107 and left pivot arm 109 at a corresponding right and left end of the latch pivot tube 113. Therefore as mentioned above, the latch pivot tube 113 may also be considered to be a structural connecting member, or a structural horizontal connecting member, for connecting the right pivot arm 107 to the left pivot arm 109. The latch handle 112 is shown positioned approximately centered on the centerline 401 of the brush guard assembly 100. Positioning the latch handle 112 on the centerline 401 facilitates a uniform, or equal, pulling force by an operator upon the left and right sides of the latch mechanism. For example, in FIG. 4, the latch mechanism includes two tension springs 122, which are connected to the latch pin 114 at one end of the tension springs 122. The other ends of the tension springs 122 are fixedly connected to a mounting hardware, such as two spring support bolts 121, each of which attach to the right pivot arm 107 and left pivot arm 109. Because the tension springs 122 are positioned at the right and left end of the latch pin 114, pulling the latch pin 114 forward, via handle 112 at the centerline 401, exerts an equally distributed pulling force upon the two tension springs 122.

The tension springs 122 are helical or coil tension springs and may have either attachment loops or attachment hooks at each end. Therefore the tension springs 122 may be hooked onto the latch pin 114, or in the case of loop ends, the latch pin 114 may inserted through the tension spring 122 end loops. The latch pin 114 may include two end caps 115 which may provide a shoulder diameter to prevent the latch pin 114 from horizontal motion. In other words, the end caps 115 may have a rim, or shoulder, with a diameter larger than the latch pin slots 120, and also larger than the tension spring 122 hook or loop diameters, so that the rim abuts the right pivot arm 109, left pivot arm 107, or the tension spring 122 loops or hooks, as needed corresponding to right and left horizontal motion of the latch pin 114, to prevent the latch pin 114 from slipping out of position, and/or out of the spring loops or spring hooks.

In some embodiments, the spring support bolts 121 may be inserted through spring support bolt mounting holes 125, which are drilled through on both the right pivot arm 107 and left pivot arm 109, and held in place by inner nuts 123 and outer nuts 124. The inner nuts 123 and outer nuts 124 may be, for example, nylon insert lock nuts or serrated flange nuts, so that the nuts are secure and will not loosen due to vibration caused by operation of the vehicle 104. The tension springs 122 may be hooked onto a shoulder portion of the spring support bolts 121. Or where tension springs 122 have end loops, the spring support bolts 121 may be inserted through the end loops before being attached to the right and left pivot arms 107, 109, via the inner nuts 123 and outer nuts 124. Other embodiments may support the tension springs 122 using J-bolts, U-bolts, or a welded support, such as a welded or press fit dowel that is welded to, or press fit into, the right pivot arm 107 and left pivot arm 107 at the point were the spring support bolt mounting hole 125 is shown in FIG. 3 and other FIGS. If welded or press fit dowels are used, the dowels may include a capped end to prevent the tension springs 122 from slipping off the dowels. In another embodiment, the spring support bolt mounting holes 125 may be tapped to accept the threading of a spring support bolt directly without the need for a nut and bolt assembly.

Turning to FIG. 5, the brush guard assembly 100 may include various guard tubes such as main guard tube 111, left guard tube 110 which is attached to left pivot arm 109, and right guard tube 108 which is attached to right guard tube 110. The right guard tube 108 and the left guard tube 110 may be positioned so as to form various angles with the corresponding right pivot arm 107 and left pivot arm 109. For example, the right guard tube 108 may have an upward angle and also a backward angle such that anything coming in contact with the guard tube would be directed or pushed outwardly away from the vehicle 104 front end. Likewise the main guard tube 111 may have a curvature such that angles are formed with respect to the right pivot arm 107 and left pivot arm 109. It is to be understood that the various guard tubes are exemplary of guard tube members, and that, guard tubes are guard tube members having a circular cross section. It is therefore to be understood that guard members may have any suitable cross section and that such guard member cross-sections would remain in accordance with the embodiments herein disclosed. For example, the guard members may have a square cross-section, or may be flat metal bars having a width greater than the bar thickness, that is, metal bars having a rectangular cross-section. Further, additional or fewer guard members may be present in various embodiments. For example, in FIG. 5, a second right guard tube may be attached to right pivot arm 107, and positioned above currently shown right guard tube 108. Likewise, a corresponding second left guard tube may be attached to left pivot arm 109 positioned symmetrically to the second right guard tube. Therefore, the pivoting brush guard 103 may have various configurations that would remain in accordance with a brush guard 103 and brush guard assembly 100 as herein disclosed. Further, guard members may be attached to the pivoting brush guard 103 in any suitable manner including press fitting to the right pivot arm 107 and left pivot arm 109, welding, or using nut and bolt assemblies.

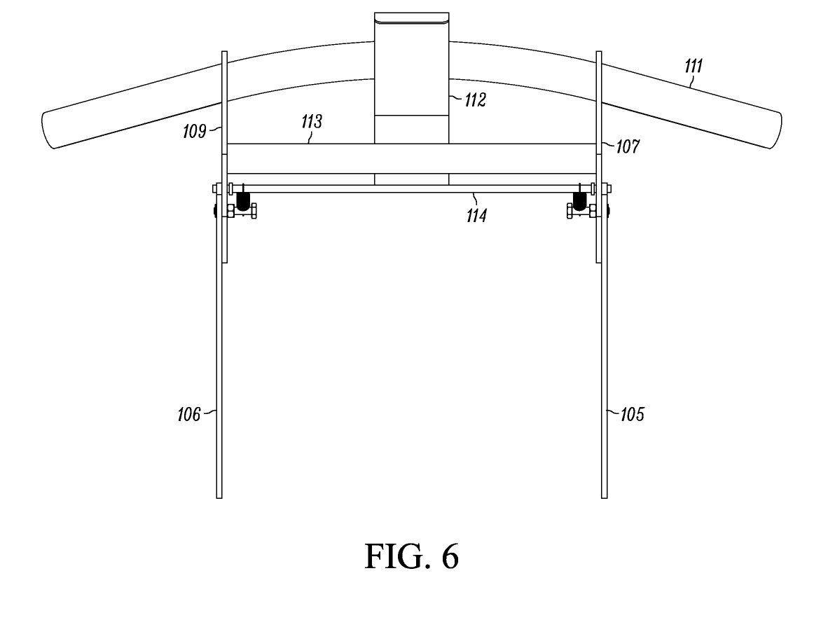

FIG. 6 provides a bottom view of the brush guard assembly 100 and shows how the latch handle 112 is positioned above the latch pivot tube 113, and is attached to the latch pin 114. The latch handle 112 may be connected to the latch pin 114 in any suitable manner including attaching with one or more screws, nut and bolt assemblies, or by welding the handle 112 to the latch pin 114.

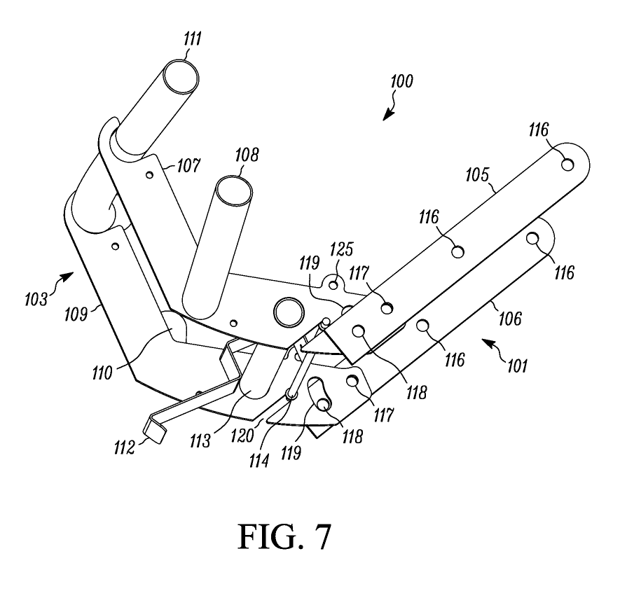

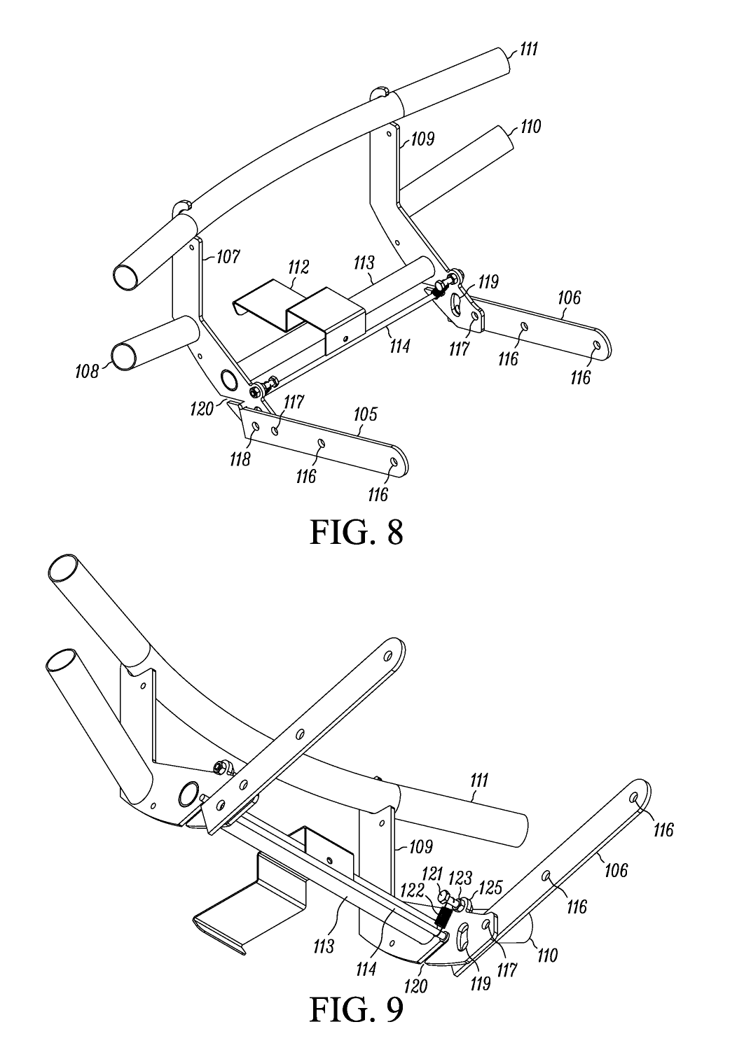

FIGS. 7, 8 and 9 are perspective views, rotated at various angles, which are useful for understanding the pivoting action and latching action of the various embodiments and therefore are henceforth referred to collectively for the following description. The perspective views of FIGS. 7, 8 and 9 are also particularly useful for understanding the pivot slot 119 and the shoulder bolt hole 118 operation in accordance with the embodiments.

FIG. 7 provides a view of the internal surface of left brace member 106 which is in contact with the external surface of left pivot arm 109. As can be seen in FIG. 7, left pivot arm 109 has a pivot slot 119 which is aligned with a shoulder bolt hole 118. Right pivot arm 107 also has a pivot slot 119 and right brace member 105 has a corresponding shoulder bolt hole 118. A shoulder bolt, and a corresponding washer and nut assembly, may be used to secure the shoulder bolt within the shoulder bolt hole 118. When the pivoting brush guard 103 is pivoted, or rotated, away from the vehicle 104 front end, the pivot slots 119, on both the right pivot arm 107 and left pivot arm 109, track the motion of the pivoting brush guard 103 up to a maximum angle at which point the motion is halted by the shoulder bolts. It is to be understood that, although pivot slots 119 are referred to as “slots,” the pivot slots 119 are actually arced and elliptical in order to track the rotational, or pivotal, motion of the pivoting brush guard 103. Therefore, the terminology “pivot slot” as used herein, refers to an appropriate shape, such as the elliptical and arced geometry shown in the FIGS. as pivot slots 119, such as in FIG. 7, such that a follower or stop, such as the shoulder bolt described above, may follow the motion of the pivoting brush guard 103 and/or remain stationary with respect to the pivot slots 119, to limit the pivoting brush guard's degree of rotation or pivoting.

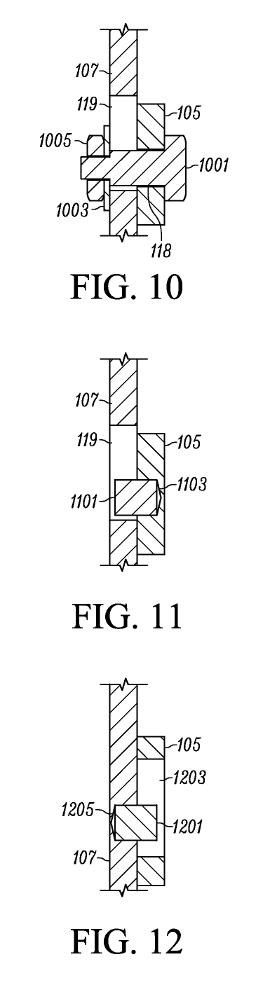

Therefore, use of a shoulder bolt is one possible embodiment of a rotation or pivot stop, and, therefore, although a shoulder bolt is used in the presently described embodiment, other embodiments may provide a rotation stop in a different way. Returning briefly to FIG. 3, a cross-section is taken with respect to the right brace member 105 and right pivot arm 107. Alternative embodiments for providing a rotation stop are illustrated in the cross-sectional views of FIGS. 10 through 12. For example, FIG. 10 illustrates an embodiment employing a shoulder bolt 1001, along with a washer 1003 and lock nut 1005 assembly. The lock nut 1005 may be, for example, a nylon insert lock nut or a serrated flange nut, so that the nut is secure and will not loosen due to vibration caused by operation of the vehicle 104.

FIG. 11 illustrates another embodiment where, instead of a shoulder bolt, a press fit dowel 1101 is used to stop the pivoting brush guard 103 rotation. The press fit dowel 1101 may be press fit into a bore 1103 in the right brace member 105. The bore 1103 may be completely through the right brace member 105 in some embodiments. It is to be understood that FIGS. 10 through 12 illustrate embodiments with respect to the right brace member 105 and right pivot arm 107 for purposes of simplicity of explanation and that the other side of the brush guard assembly 100, that is, the left side which includes left brace member 106 and left pivot arm 109, will have a symmetrical implementation of the structure shown with respect to the right side as in the FIGS. 10 through 12. Therefore, for example with respect to FIG. 11, the left brace member 106 would have a similar press fit dowel 1101 to that of the right brace member 105. The press fit dowel 1101 may have a length extending from the bore 1103, as measured from the surface of right brace member 105, approximately equal to the width of the pivot slot 119, or may be slightly shorter than, or slightly longer than, the pivot slot 119 width, provided that the press fit dowel 1101 can withstand the shear force due to the weight of the pivoting brush guard 103 when the pivoting brush guard 103 is in the deployed position. The press fit dowel 1101 may be welded in place in some embodiments.

FIG. 12 illustrates an alternative embodiment wherein the pivot slots are in the right and left brace members rather than in the right and left pivot arms. For example, in FIG. 12, the right brace member includes a pivot slot 1203, and the right pivot arm 107 has a press fit dowel 1201 press fit into a boring 1205. For the embodiment of FIG. 12, the press fit dowel 1201 acts as a follower that follows the rotational motion of the pivoting brush guard 103, within the stationary pivot slot 1203. Therefore, as shown in FIGS. 10 through 12, the embodiments include a pivot stop that may be a shoulder bolt or a dowel. Further while some embodiments will include symmetrical pivot stops located on each side of the pivoting brush guard 103, in some embodiments there may be only a single pivot stop that is only located on one side of the pivoting brush guard 103.

Returning to the perspective views of FIGS. 7 through 9, the brush guard pivots 117 may also be implemented in various ways in the various embodiments. For example, a nut and bolt assembly may be used to pass through the brush guard pivot holes 117 of the brace members and their corresponding pivot arms. In alternative embodiments, either the brace members 105, 106 or the pivot arms 107, 109 may have press fit pivot dowels, similar to the press fit dowels illustrated in FIGS. 10 through 12. The corresponding mating piece, (i.e. the brace members 105, 106 or the pivot arms 107, 109), depending on which item has the pivot dowel, will have a corresponding pivot hole to accept the pivot dowel. The tolerance of the pivot hole diameter will be large enough to allow for rotation of the pivot dowel, within the pivot hole (or rotation about the pivot dowel if it is stationary by being located on the brace members 105, 106), such that the pivoting brush guard 103 may rotate or pivot. In some embodiments, a press fit bushing or a bearing may also be included within the pivot hole to further provide freedom or rotation for the pivot dowel. Thus, the pivoting brush guard 103 is pivotably connected to the stationary frame brace 101, and the right and left brace members 105, 106, via a pivot point which may include a pivot dowel or a pivot bolt, etc.

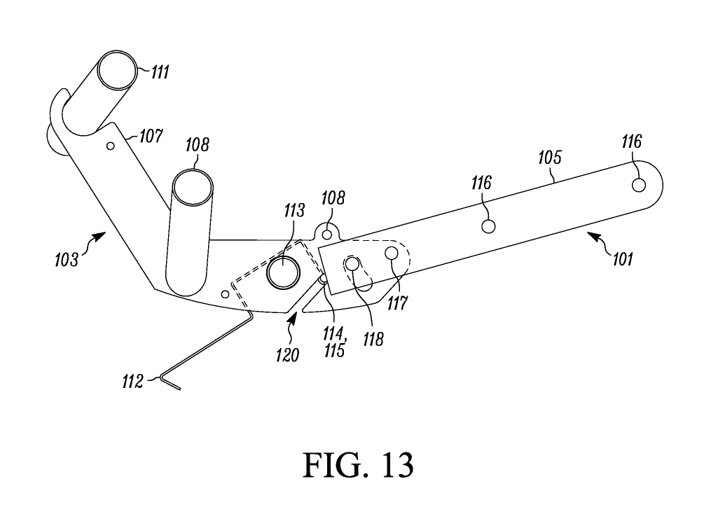

Returning briefly to FIG. 3, the pivoting brush guard 103 is shown in an upright, or deployed position. To tilt the pivoting brush guard 103, the operator pulls forward, and slightly upwards, on latch handle 112, to pull the latch pin 114 out of the latch pin slot 120, so that the shear force between the pivoting brush guard 103 and the stationary frame brace 101 is relieved. The pivoting brush guard 103 may then be pivoted, or tilted, about the brush guard pivot 117. FIG. 13 illustrates a side view, as in FIG. 3, of the pivoting brush guard 103 in a tilted, or un-deployed position. The latch pin 114 rests within the latch pin slot 120, upon the front-most ends of the right and left brace members, 105,106. The shoulder bolt hole 118 moves into a position at the top of the pivot slot 119 so that, for example, a shoulder bolt 1001 comes into contact with the top of the pivot slot 119 and prevents further tilting motion.

When the pivoting brush guard 103 is lifted back into its deployed or upright position, the latch pivot tube 113 will contact the latch pin handle 112 and place an upward force such that the latch pin 114 will be move slightly forward within the latch pin slot 120. As the latch pin 114 moves within the latch pin slot 120, the tension springs 122 will act to pull the latch pin 114 back into the slot and therefore back into a latched position as the latch pin 114 is moved over the upper surface of the right and left brace members 105, 106. The operator may then allow the pivoting brush guard 103 to rest upon the latch pin 114 and place a shear force on the latch pin 114 which will be again located between the pivoting brush guard 103 and the right and left brace members 105, 106. The latch pin 114 contacts the right and left brace members 105, 106, and therefore maintains the pivoting brush guard 103 in an upright or deployed position.

Other variations that would be equivalent to the herein disclosed embodiments may occur to those of ordinary skill in the art and would remain in accordance with the spirit and scope of embodiments as defined herein by the following claims.

What is claimed is:

1. A brush guard comprising:
a pivoting brush guard assembly, pivotably connected to a stationary frame brace for mounting to a vehicle front, wherein said pivoting brush guard assembly is latchable in an upright position via a latch mechanism, and pivotable away from said vehicle front by releasing said latch mechanism.

2. The brush guard of claim 1, wherein said latch mechanism further comprises:
a latch pin;
at least one tension spring connected to said latch pin and to said pivoting brush guard assembly, wherein said at least one tension spring exerts a pulling force to pull said latch pin into a latched position; and
wherein said latch pin sits on said stationary frame brace and supports said brush guard assembly, when said brush guard assembly is latched in said upright position.

3. The brush guard of claim 2, wherein said pivoting brush guard assembly further comprises:
a right and left pivot arm, each pivot arm having a latch pin slot for accepting said latch pin, and a brush guard pivot point for pivoting said pivoting brush guard assembly.

4. The brush guard of claim 3, wherein said right pivot arm and said left pivot arm each include a pivot slot, wherein said pivoting brush guard assembly further comprises:
a right and left shoulder bolt, through said pivot slot of corresponding said right and left pivot arm, and through a corresponding right and left shoulder bolt hole of said stationary frame brace, wherein said shoulder bolt limits a pivot angle of said pivoting brush guard assembly when said pivoting brush guard assembly is pivoted about said brush guard pivot point, said limit determined by a length of said pivot slots, when said shoulder bolt is placed in contact with a top of said pivot slots, wherein said length of said pivot slots corresponds to said pivot angle.

5. The brush guard of claim 3, wherein said right pivot arm and said left pivot arm each include a pivot slot, and wherein said stationary frame brace comprises a right and left brace member, each brace member including a shoulder dowel pin, wherein said shoulder dowel pin is positioned within said pivot slot, wherein said shoulder dowel pin provides a limit of a pivot angle of said pivoting brush guard assembly when said pivoting brush guard assembly is pivoted about said brush guard pivot point, said limit determined by a length of said pivot slot, when said shoulder dowel pin is placed in contact with a top of said pivot slot, wherein said length of said pivot slot corresponds to said pivot angle.

6. The brush guard of claim 2, wherein said latch mechanism further comprises:
a latch handle connected to said latch pin, for pulling said latch pin out of said latched position.

7. The brush guard of claim 1, wherein said stationary frame brace comprises:
a right brace member and a left brace member, each brace member having at least two mounting bolt holes, and a brush guard pivot point.

8. The brush guard of claim 7, wherein said pivot point is a dowel pin.

9. The brush guard assembly of claim 3, further comprising:
at least one brush guard member having a right end and a left end and connected to said right pivot arm at said right end and connected to said left pivot arm at said left end.

10. A brush guard comprising:
a stationary frame brace for mounting to a vehicle front, said stationary frame brace including a right and left brace member;
a pivoting brush guard assembly including a right and left pivot arm, each pivot arm including a latch pin slot;
a structural connecting member, connected to said right pivot arm at a first end of the structural connecting member, and connected to said left pivot arm at a second end of the structural connecting member;
a latch pin, positioned within said latch pin slots of said right and left pivot arms;
a right tension spring connected to said latch pin and to said right pivot arm; and
a left tension spring connected to said latch pin and to said left pivot arm.

11. The brush guard of claim 10, wherein at least one of said right pivot arm or said left pivot arm includes a pivot slot, and wherein at least said corresponding right or left brace member includes a shoulder bolt hole, wherein said pivoting brush guard assembly further comprises:
a shoulder bolt, through said shoulder bolt hole and said pivot slot, wherein said shoulder bolt provides a limit of a pivot angle of said pivoting brush guard assembly when said pivoting brush guard assembly is pivoted about a pivot point, said limit determined by a length of said pivot slot, when said shoulder bolt is placed in contact with a top of said pivot slot, wherein said length of said pivot slot corresponds to said pivot angle.

12. The brush guard of claim 10, wherein at least one of said right pivot arm or said left pivot arm includes a pivot slot, and wherein at least said corresponding right or left brace member includes a shoulder dowel pin, wherein said shoulder dowel pin is positioned within said pivot slot, wherein said shoulder dowel pin provides a limit of a pivot angle of said pivoting brush guard assembly when said pivoting brush guard assembly is pivoted about a pivot point, said limit determined by a length of said pivot slot, when said shoulder dowel pin is placed in contact with a top of said pivot slot, wherein said length of said pivot slot corresponds to said pivot angle.

13. The brush guard of claim 10, wherein at least one of said right brace member or said left brace member includes a pivot slot, and wherein at least said corresponding right or left pivot arm includes a shoulder dowel pin, wherein said shoulder dowel pin is positioned within said pivot slot, wherein said shoulder dowel pin limits a pivot angle of said pivoting brush guard assembly when said pivoting brush guard assembly is pivoted about a pivot point, said limit determined by a length of said pivot slot, when said shoulder dowel pin is placed in contact with a top of said pivot slot, wherein said length of said pivot slot corresponds to said pivot angle.

14. The brush guard of claim 10, wherein each of said right pivot arm, said left pivot arm, said right brace member, and said left brace member, includes a pivot hole, and wherein said pivoting brush guard assembly further comprises:
a right pivot bolt, through said pivot holes of said right pivot arm and said right brace member; and
a left pivot bolt, through said pivot holes of said left pivot arm and said left brace member.

15. The brush guard of claim 10, wherein at least one of said right pivot arm or said left pivot arm includes a pivot hole, and wherein at least said corresponding right or left brace member includes a pivot dowel.

16. The brush guard of claim 10, wherein at least one of said right brace member or said left brace member includes a pivot hole, and wherein at least said corresponding right or left pivot arm includes a pivot dowel.

17. The brush guard of claim 10, wherein said pivoting brush guard assembly further comprises:
a guard member having a right end and a left end, and a length greater than said structural connecting member, said guard member connected to an upper end of said right pivot arm and connected symmetrically to a corresponding upper end of said left pivot arm, said length of said guard member such that said right end and said left end extend outwardly, respectively, from said right pivot arm and said left pivot arm.

18. The brush guard of claim 10, wherein said pivoting brush guard assembly further comprises:
a right guard member connected to said right pivot arm and extending outwardly therefrom in a right direction; and
a left guard member connected to said left pivot arm and extending outwardly therefrom in a left direction, said left guard member being symmetrical to said right guard member.

19. A method of operating a pivoting brush guard assembly that is pivotably connected to a stationary frame brace for mounting to a vehicle front, wherein said pivoting brush guard assembly is latchable in an upright position via a latch mechanism, and pivotable away from said vehicle front by releasing said latch mechanism, the method comprising:
pulling a latch pin forward within a latch pin slot and out of a latched position;
tilting said brush guard assembly forward by pivoting said brush guard assembly about a pivot point.

20. The method of claim 19, further comprising:
pivoting said brush guard assembly back into said upright position by pivoting said brush guard assembly about said pivot point, and allowing at least one tension spring to pull said latch pin back into said latched position.
